(19) United States
(12) Patent Application Publication
(10) Pub. No.: US 2019/0369232 A1
(43) Pub. Date: Dec. 5, 2019

(54) IN-VEHICLE RADAR DETECTION SYSTEM

(71) Applicant: CUBTEK INC., Zhubei City (TW)

(72) Inventors: SAN-CHUAN YU, Zhubei City (TW); SHYH-JONG CHUNG, Zhubei City (TW); YU-WANG HU, Zhubei City (TW); WEN-CHENG WANG, Zhubei City (TW); HONG-LUN CHEN, Zhubei City (TW)

(21) Appl. No.: 16/041,017

(22) Filed: Jul. 20, 2018

(30) Foreign Application Priority Data
Jun. 5, 2018 (TW) 107119236

(51) Int. Cl. G01S 13/93; G01S 13/04

(52) U.S. Cl. CPC G01S 13/931; G01S 2013/9385; G01S 2013/9332; G01S 13/04

(57) ABSTRACT

An in-vehicle radar detection system includes a first radar module and a second radar module separately mounted on a lateral of a vehicle. The first radar module gives a first radar signal that defines a first detection range. The second radar module gives a second radar signal that defines a second detection range. The first radar module and the second radar module give a first radar signal and a second radar signal toward each other, respectively, so that the first detection range and the second detection range fully cover the lateral of the vehicle, thereby providing full detection without any dead spaces.

### BACKGROUND OF THE INVENTION

### 1. Technical Field

The present invention relates to in-vehicle radar applications, and more particularly to an in-vehicle radar detection system with improved dead-space detection.

### 2. Description of Related Art

Blind-spot detection systems represent a modern type of automotive safety functionality that uses sensors mounted on a vehicle to detect whether there is an obstacle in any blind-spot area around the vehicle. In the event that a positive result is confirmed by the system, warning light or warning sound is given to inform the car driver of this, so that the driver can timely stop the car or avoid the obstacle, thereby preventing accidents that might otherwise be raised from the driver's negligence or obstructed line of sight.

The existing blind-spot detection systems are most image-based and/or radar-based. Image detection relies on video cameras that take images around the relevant car and uses the resulting image signals to determine whether there is any obstacle in any of the car's blind-spot areas. However, image detection is weather-sensitive and may thus give false alarms or fail to perform detection.

On the other hand, radar detection is less sensitive to weather factors and in turn more reliable than image detection. In practice, radar sensors are mounted at a car's right/left lateral or front/rear ends. For example, US Patent Application Publication No. US20070200747A1 discloses a radar apparatus and radar system for a vehicle, wherein radar apparatuses are mounted at the right and left sides of a vehicle to each give a radar signal that defines a detection area outside the car in a manner that the detection areas of adjacent radar apparatuses overlap each other.

However, the overlap is so narrow that dead spaces tend to exist between the adjacent detection areas. The term “dead space” refers to an area not covered by any radar apparatus in terms of detection. In such a case, when an obstacle exists in such a dead space, no warning will be given because no radar apparatus can detect it.

In order to minimize dead spaces and improve blind-spot detection, one known solution is to increase the number of radar apparatuses installed and in turn increase the overall overlap area. As an alternative, wide-detection radar devices of high specifications may be used to maximize the detection ranges.

However, use of additional radar devices increases not only the overall costs of the resulting blind-spot detection system, but also the risk of interference between detection signals coming from adjacent radar devices, making the detection accuracy of the system undermined. On the other hand, use of wide-detection radar devices does help to reduce the number of radar devices required, but the high-specification radar devices are much more expensive than normal products, meaning that the overall costs of the resulting blind-spot detection system can be significantly increased.

### SUMMARY OF THE INVENTION

To address the foregoing issues, the present invention provides an in-vehicle radar detection system, which comprises a first radar module and a second radar module that are mounted at a lateral of a vehicle and give a first radar signal and a second radar signal, respectively, toward each other, so that their first imaginary signal line and second imaginary signal line intersect each other, thereby maximizing an overlap between the first detection range and the second detection range, and in turn eliminating weakness in detection of dead spaces.

According to one embodiment of the present invention, an in-vehicle radar detection system comprises a first radar module, being mounted at one lateral of a vehicle, and giving a first radar signal, wherein the first radar signal has a cone-like first detection range extending outward from the first radar module, and a first imaginary signal line extends outward from a center of the first detection range; and a second radar module, being mounted at the lateral and separated from the first radar module, and giving a second radar signal, wherein the second radar signal has a cone-like second detection range extending outward from the second radar module, and a second imaginary signal line extends outward from a center of the second detection range, in which the first imaginary signal line and the second imaginary signal line intersect each other.

With the foregoing configuration, the first radar module and the second radar module are such mounted at the lateral of the vehicle that the first radar signal of the first radar module and the second radar signal of the second radar module are given toward each other, so that the first imaginary signal line of the first radar signal and the second imaginary signal line of the second radar signal intersect each other. Thereby, the first detection range and the second detection range overlap in an enlarged area, making the traditionally recognized dead spaces existing between detection ranges of conventional radar devices well covered.

Moreover, the disclosed in-vehicle radar detection system can effectively enhance its overall detection range using only two radar module. As compared to the existing systems using two or more radar devices or using radar devices of high specifications, the present invention requires lower costs and provides more effective solution to dead-space detection.

### BRIEF DESCRIPTION OF THE DRAWINGS

FIG. 1 is a block diagram of a system of the present invention.

FIG. 2 is a lateral applied view of the present invention mounted on a lateral of a vehicle.

FIG. 3 is a top applied view of the present embodiment.

FIG. 4 is a partial, enlarged view of FIG. 3.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

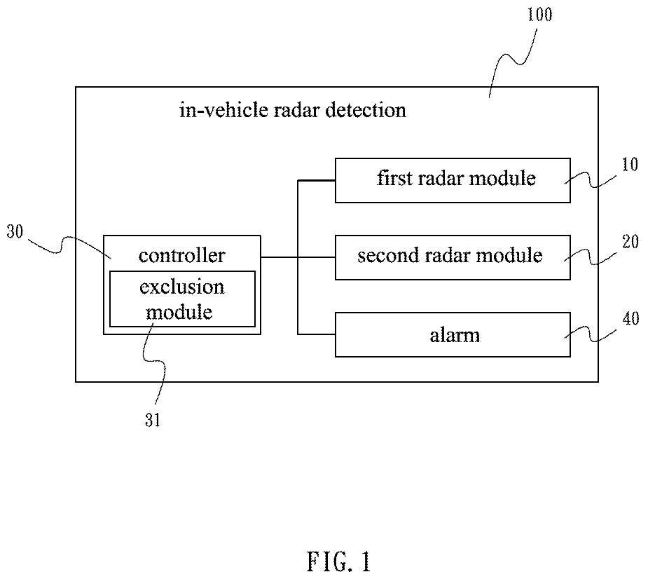

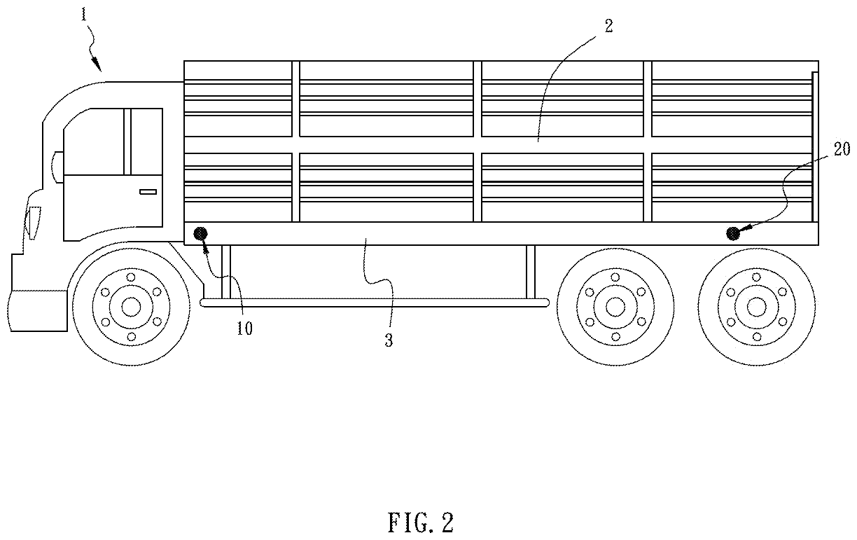

Referring to FIG. 1 through FIG. 4, the present invention provides an in-vehicle radar detection system 100, which comprises: a first radar module 10, a second radar module 20, a controller 30, and an alarm 40. The first radar module 10 and the second radar module 20 are mounted separately at the same lateral 2 or the opposite laterals 2 of the vehicle 1. In the present embodiment, the first radar module 10 and the second radar module 20 are mounted at the same lateral 2, and are each close to one end of the lateral 2. In particular, the first radar module 10 is close to the vehicle front and the second radar module 20 is close to the vehicle rear. The first radar module 10 and the second radar module 20 are installed at the same altitude on the lateral 2, as shown in FIG. 2.

The lateral 2 has an edge segment 3 between the first radar module 10 and the second radar module 20. It is to be noted that the vehicle 1 may be any type of vehicles, and the lateral 2 may be the front, the rear, the left side or the right side of the vehicle 1 while the lateral 2 is not limited to the inner surface nor the outer surface of the vehicle 1. In the present embodiment, the vehicle 1 is a trailer.

The controller 30 is electrically connected to the first radar module 10, the second radar module 20, and the alarm 40. The controller 30 controls the first radar module 10 to give a first radar signal 11, and controls the second radar module 20 to give a second radar signal 21. When the first radar signal 11 of the first radar module 10 or the second radar signal 21 of the second radar module 20 detects there is an object, the controller 30 triggers the alarm 40 to give a warning signal to warn the driver.

For preventing the first radar signal 11 and the second radar signal 21 from mutual interference when they perform detection, the controller 30 controls the first radar signal 11 of the first radar module 10 and the second radar signal 21 of the second radar module 20 to be time-division, frequency-division or orthogonal signals. The first radar signal 11 and the second radar signal 21 give signals at a frequency of 77 GHz or 77.25 GHz.

The first radar signal 11 given by the first radar module 10 has a cone-like first detection range 111 extending from the first radar module 10 toward the outside of the vehicle 1. A first imaginary signal line 12 extends from the center of the cone-like first detection range 111 toward the outside of the vehicle 1. Therein, the first radar module 10 gives the first radar signal 11 toward the second radar module 20, and the first imaginary signal line 12 extends toward the second radar module 20.

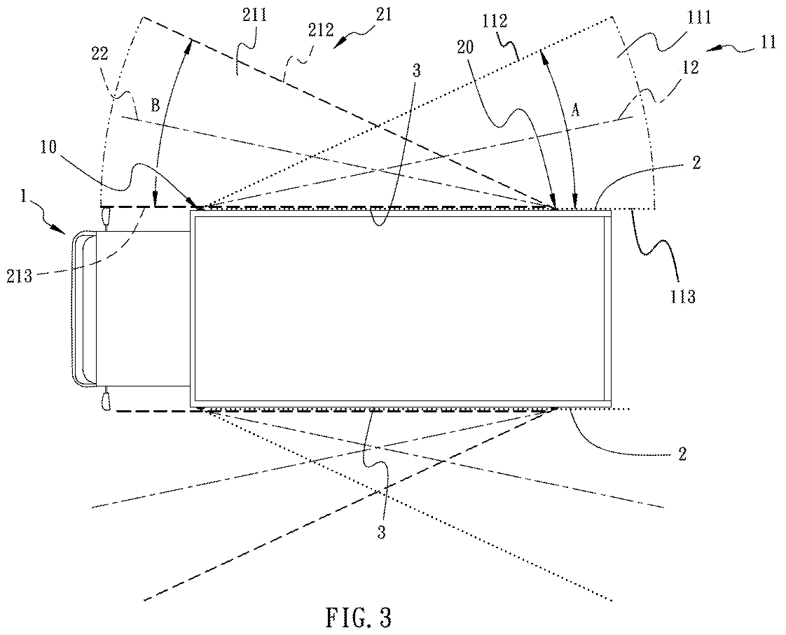

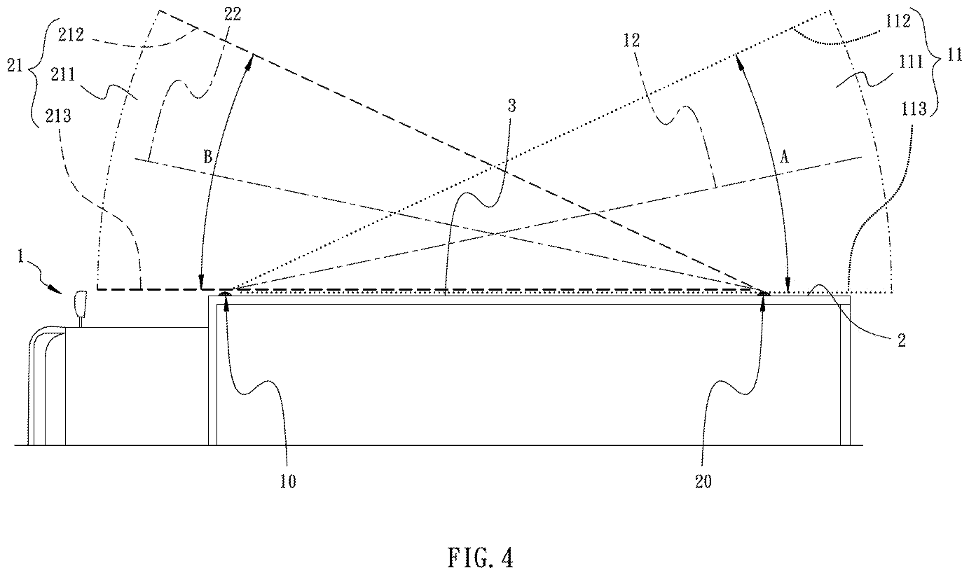

Furthermore, the first detection range 111 has a first outer border 112 and a first inner border 113. The first outer border 112 extends from the first radar module 10 toward the outside of the vehicle 1, and the first inner border 113 extends from the first radar module 10 toward the second radar module 20 along the edge segment 3. Referring to FIG. 3 and FIG. 4, in the present embodiment, the first inner border 113 is close to the edge segment 3 and is at the outside of the vehicle 1. The first detection range 111 does not cover the edge segment 3.

Additionally, the first outer border 112 and the first inner border 113 include a first angle at center A. The first angle at center A is greater than 0 degree and smaller than 45 degrees. In the present embodiment, the first angle at center A is about 30 degrees.

The controller 30 further has an exclusion module 31. The exclusion module 31 makes the second radar module 20 ignored in the first detection range 111. Particularly, the first radar module 10 gives the first radar signal 11 toward the second radar module 20, and the second radar module 20 is located in the first detection range 111, so when the first radar signal 11 reaches the second radar module 20, a reflected signal is generated to indicate the distance between the second radar module 20 and the first radar module 10. In use, the location of the second radar module 20 can be preset in the exclusion module 31 of the controller 30, so that when the first radar signal 11 reaches an object and the reflected signal is generated, the exclusion module 31 of the controller 30 can determined whether the detected object is the second radar module 20 according to the reflected signal. If the result is positive, the exclusion module 31 recognizes the object as the second radar module 20 and keeps the alarm 40 un-triggered. With this mechanism, error warning due to detection of the second radar module 20 is prevented.

The second radar signal 21 given by the second radar module 20 has a cone-like second detection range 211 extending from the second radar module 20 toward the outside of the vehicle 1. A second imaginary signal line 22 extends from the center of the cone-like second detection range 211 toward the outside of the vehicle 1. The second radar module 20 gives the second radar signal 21 toward the first radar module 10, and the second imaginary signal line 22 extends toward the first radar module 10. The first imaginary signal line 12 and the second imaginary signal line 22 intersect each other in a top-down orthographic projection of the vehicle 1. In other words, the first imaginary signal line 12 and the second imaginary signal line 22 intersect each other in a horizontal plane, as shown in FIG. 3.

Moreover, the first detection range 111 and the second detection range 211 overlap at the outside of the vehicle 1 in an area aligned with the edge segment 3. In the present embodiment, the first imaginary signal line 12 and the second imaginary signal line 22 intersect by the side of the edge segment 3. Thereby, the first detection range 111 and the second detection range 211 jointly cover the whole lateral 2 and eliminate virtually all dead spaces.

The second detection range 211 has a second outer border 212 and a second inner border 213. The second outer border 212 extends from the second radar module 20 toward the outside of the vehicle 1, and the second inner border 213 extends from the second radar module 20 toward the first radar module 10 along the edge segment 3. Referring to FIG. 3 and FIG. 4, in the present embodiment, the second inner border 213 is close to the edge segment 3 and at the outside of the vehicle 1. The second detection range 211 does not cover the edge segment 3. Therein, the first detection range 111 and the second detection range 211 overlap each other at an area next to the edge segment 3.

In addition, the second outer border 212 and the second inner border 213 include a second angle at center B. The second angle at center B is greater than 0 degree and smaller than 45 degrees. In the present embodiment, the second angle at center B is equal to the first angle at center A and is also about 30 degrees. The size of the first and second angle at centers A, B as well as the distance between the first and second radar modules 10, 20 jointly define the areas of the first detection range 111 and the second detection range 211 as well as the area of the overlap therebetween. Thus, when the second angle at center B is equal to the first angle at center A, the first detection range 111 and the second detection range 211 are equal, thereby maximizing the overlap between the first detection range 111 and the second detection range 211, and in turn covering dead space around the lateral 2.

Furthermore, the exclusion module 31 of the controller 30 makes the first radar module 10 ignored in the second detection range 211. Particularly, the second detection range 211 gives the second radar signal 21 toward the first radar module 10, and the first radar module 10 is located in the second detection range 211, so when the second radar signal 21 reaches the first radar module 10, a reflected signal is generated to indicate the distance between the first radar module 10 and the second radar module 20. In use, the location of the first radar module 10 can be preset in the exclusion module 31 of the controller 30, so that when the second radar signal 21 reaches an object and the reflected signal is generated, the exclusion module 31 of the controller 30 can determined whether the detected object is the first radar module 10 according to the reflected signal. If the result is positive, the exclusion module 31 recognizes the object as the first radar module 10 and keeps the alarm 40 un-triggered. With this mechanism, error warning due to detection of the first radar module 10 is prevented.

To sum up, the present invention provides the following benefits:

First, the first radar signal 11 and the second radar signal 21 are given toward each other, so that the first imaginary signal line 12 and the second imaginary signal line 22 intersect each other. This increases the detection range covered by the first detection range 111 and the second detection range 211, thereby effectively reducing dead space and improving road safety.

Second, the present invention can effectively enhance detection range with only two radar modules, thereby effectively reducing the number of required radar modules, and in turn lowering the costs of the in-vehicle radar detection system 100 of the present invention.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An in-vehicle radar detection system, comprising:
a first radar module, being mounted at one lateral of a vehicle, and giving a first radar signal, wherein the first radar signal has a cone-like first detection range extending outward from the first radar module, and a first imaginary signal line extends outward from a center of the first detection range; and
a second radar module, being mounted at the lateral and separated from the first radar module, and giving a second radar signal, wherein the second radar signal has a cone-like second detection range extending outward from the second radar module, and a second imaginary signal line extends outward from a center of the second detection range, in which the first imaginary signal line and the second imaginary signal line intersect each other.

2. The in-vehicle radar detection system of claim 1, wherein the first imaginary signal line and the second imaginary signal line intersect each other in a top-down orthographic projection of the vehicle.

3. The in-vehicle radar detection system of claim 2, wherein the lateral has an edge segment between the first radar module and the second radar module, and the first detection range and the second detection range overlap in an area outside the vehicle aligned with the edge segment.

4. The in-vehicle radar detection system of claim 1, further comprising a controller electrically connected to the first radar module and the second radar module, wherein the controller controls the first radar module to give the first radar signal, and controls the second radar module to give the second radar signal, and the controller has an exclusion module, which makes the second radar module ignored in the first detection range and make the first radar module ignored in the second detection range.

5. The in-vehicle radar detection system of claim 3, wherein the first detection range has a first outer border and a first inner border, in which the first outer border extends from the first radar module toward an outside of the vehicle, and the first inner border extends from the first radar module toward the second radar module along the edge segment.

6. The in-vehicle radar detection system of claim 5, wherein the second detection range has a second outer border and a second inner border, in which the second outer border extends from the second radar module toward the outside of the vehicle, and the second inner border extends from the second radar module toward the first radar module along the edge segment.

7. The in-vehicle radar detection system of claim 6, wherein the first outer border and the first inner border jointly define a first angle at center that is greater than 0 degree and smaller than 45 degrees, and the second outer border and the second inner border jointly define a second angle at center that is greater than 0 degree and smaller than 45 degrees.

8. The in-vehicle radar detection system of claim 2, wherein the first radar module and the second radar module are mounted at an identical altitude.
